(19) United States
(12) Patent Application Publication
(10) Pub. No.: US 2017/0165781 A1
(43) Pub. Date: Jun. 15, 2017

(54) ADDITIVE MANUFACTURING OF TITANIUM ARTICLE

(71) Applicant: LINDE AKTIENGESELLSCHAFT, Munich (DE)

(72) Inventors: Walter Mark Veldsman, Guildford (GB); Martin Ball, Guildford (GB); Jim Fieret, Hook (GB); Ernst Miklos, Kirchheim (DE)

(21) Appl. No.: 15/039,582

(22) PCT Filed: Nov. 27, 2014
(86) PCT No.: PCT/GB2014/000491

§ 371 Date: May 26, 2016

(30) Foreign Application Priority Data
Nov. 27, 2013 (GB) 1320888.9

(51) Int. Cl. B23K 10/02; B23K 26/342; B22F 3/105; B23K 9/23; B33Y 10/00; B23K 35/38; B23K 9/04; B23K 26/00

(52) U.S. Cl. CPC B23K 10/027; B23K 9/04; B23K 26/342; B23K 26/0006; B23K 9/23; B33Y 10/00; B23K 35/383; B22F 3/1055; B23K 2203/14

(57) ABSTRACT

A method of manufacturing an article comprising titanium and/or titanium alloy using an additive manufacturing method comprising: providing a substrate; providing a feedstock; and fusing the feedstock to the substrate using a heat source, wherein the substrate and/or feed stock comprises titanium and/or titanium alloy, and the fusing is conducted under a shielding gas comprising an inert gas and an oxidant gas.

The invention relates to a method of manufacturing an article, such as a high value or aerospace article, comprising titanium and/or titanium alloy using an additive manufacturing method.

Additive manufacturing, also referred to as 3D printing, involves making a three-dimensional solid object from a digital model. Additive manufacturing is achieved using an additive process, where successive layers of material are laid down in different shapes using a heat source. This is in comparison to traditional machining techniques, which mostly rely on the removal of material by methods such as cutting or machining or milling. Additive manufacturing is used for both prototyping and distributed manufacturing with applications in architecture, engineering, construction, industrial design, automotive, aerospace, military, engineering, civil engineering, dental and medical industries, biotech (human tissue replacement), fashion, footwear, jewelry, eyewear and many other fields.

Titanium has a high strength-to-weight ratio, being as strong as steel but half the weight with excellent corrosion resistance and mechanical properties at elevated temperatures. Titanium and its alloys have therefore traditionally been employed in the aerospace and chemical industries. Recently, as the cost of titanium has fallen, the alloys are finding greater use in other industry sectors such as offshore.

Techniques for joining workpieces made of titanium and its alloys are known in the art and include, for example, welding, brazing and soldering techniques, using heat sources such as, for example, lasers, plasmas and arcs. There is however a need to improve the strength of articles formed by such techniques.

In joining techniques such as arc welding, shielding gases containing inert gas are typically employed in order to protect the metal under the arc from oxidation. Such oxidation may adversely affect the structural and mechanical properties of the resulting joint. US 2010/0025381 discloses a method for arc joining an object made of titanium and/or titanium alloys. The presence of an active gas such as carbon dioxide or oxygen in the shielding gas serves to stabilise the arc during the arc joining.

There is a need to provide improved techniques for manufacturing articles comprising titanium and its alloys which avoid oxidation of the titanium and/or titanium alloys, and that result in strong, high quality articles, in particular articles associated with high value and/or aerospace.

The present invention seeks to tackle at least some of the problems associated with the prior art or at least to provide a commercially acceptable alternative solution thereto.

In a first aspect the present invention provides a method of manufacturing an article comprising titanium and/or titanium alloy using an additive manufacturing method comprising:
providing a substrate;
providing a feedstock; and
fusing the feedstock to the substrate using a heat source,
wherein the substrate and/or feed stock comprises titanium and/or titanium alloy, and the fusing is conducted under a shielding gas comprising an inert gas and an oxidant gas.

Each aspect or embodiment as defined herein may be combined with any other aspect(s) or embodiment(s) unless clearly indicated to the contrary. In particular, any features indicated as being preferred or advantageous may be combined with any other feature indicated as being preferred or advantageous.

The term “additive manufacturing” as used herein may refer to a method of making a three-dimensional solid object from a digital model. Additive manufacturing is achieved using an additive process, where successive layers of material are laid down in different shapes. Additive manufacturing is considered distinct from traditional machining techniques, which mostly rely on the removal of material by methods such as cutting, machining or milling (subtractive processes). Additive manufacturing is sometimes known as “3D printing”, “additive layer manufacturing” (ALM) or “rapid prototyping”.

The term “titanium” as used herein may encompass commercially pure titanium, for example 98 to 99.5% titanium.

The term “titanium alloy” as used herein may encompass an alloy in which the major element is titanium. The term may encompass, for example, alpha titanium alloys, near alpha titanium alloys, alpha-beta titanium alloys, beta titanium alloys and titanium alloys strengthened by small additions of oxygen, nitrogen, carbon and iron. Typical titanium alloys used herein include, for example, Ti-1.5O, Ti-0.2O, Ti-0.3O, Ti-0.2O-0.2Pd, Ti-3Al-2.5V, Ti-6Al-4V, Ti-6Al-4V ELI (Extra Low Interstitials) and Ti-6Al-4V-0.06Pd. The term may also encompass proprietary titanium alloy systems as well as titanium alloys based on titanium powder metallurgy and titanium compounds, and may also encompass alloy systems such as titanium gum metal.

The term “shielding gas” as used herein may encompass a gas used during a fusing or joining technique to inhibit oxidation of a substrate, feedstock and/or workpiece.

The term “laser metal deposition” as used herein may encompass a method in which a laser beam is used to form a melt pool on a metallic substrate, into which feedstock, such as powder, is fed using a carrier gas. The feedstock then melts to form a deposit that is fusion bonded to the substrate. The carrier gas functions as the shield gas.

The term “plasma metal deposition” as used herein may encompass a method in which a plasma jet is used to form a melt pool on a metallic substrate, into which feedstock, such as powder, is fed using a carrier gas, The feedstock then melts to form a deposit that is fusion bonded to the substrate. The term may encompass plasma transferred arc techniques.

The term “selective laser melting” as used herein may encompass a method in which feedstock, such as powder, is spread on a metallic substrate. The feedstock is then fused to the substrate using a laser beam under a process gas. In contrast to laser metal deposition, the feedstock is not carried to the substrate using a carrier gas. Selective laser melting is sometimes referred to as selective laser sintering.

The term “laser joining” as used herein may encompass a joining technique in which workpieces are joined using a laser beam. The laser beam is used to melt material between the workpieces to be joined, either a portion of the workpieces themselves or a filler material. The term “laser joining” may also encompass laser hybrid welding techniques. Laser hybrid welding combines the principles of laser beam welding and arc welding. Laser hybrid welding techniques include, for example, TIG (tungsten inert gas), plasma arc, and MIG (metal inert gas) augmented laser welding.

The term “plasma joining” as used herein may encompass a joining technique in which workpieces are joined using a plasma jet. The plasma jet is used to melt material between the workpieces to be joined, either a portion of the workpieces themselves or a filler material. Plasma joining may, for example, make use of a plasma transferred arc. The term “plasma joining” may also encompass plasma hybrid welding techniques. Plasma hybrid welding techniques include, for example, TIG (tungsten inert gas), NG (metal inert gas) and laser augmented plasma welding.

The inventors have surprisingly found that high temperatures at the site of fusion results in degassing, for example oxygen degassing and/or nitrogen degassing, from titanium and titanium alloys. Such degassing may result in a reduction in the structural quality and integrity of the formed article.

In the present invention, the incorporation of oxidant gas into the shielding gas may compensate for the degassing, i.e. replace the gas lost from the substrate and/or feedstock due to the degassing. As a result, internal structural defects in the fused titanium and/or titanium alloy are reduced. Accordingly, the structural properties of the resulting article, such as the strength, are improved.

The shielding gas may also be used for purging purposes in the present invention to ensure that micro additions of the oxidants in the gas will be available for the surface of the substrate and feedstock to absorb.

The shielding gas is typically applied around the entire area of fusion.

The substrate and/or feedstock comprises titanium or titanium alloy. When only the substrate comprises titanium, it is the part of the substrate to which the feedstock is fused that comprises titanium and/or titanium alloy. Typically both the substrate and feedstock comprise titanium or titanium alloy. The substrate and/or feedstock and/or article may comprise only one titanium alloy. Alternatively, the substrate and/or feedstock may comprise multiple titanium alloys.

The article may be, for example, a high value or aerospace article.

The fusing is typically carried out using a heat source. The fusing may be carried out using an arc, a laser beam and/or a plasma jet. Preferably the fusing is carried out using a laser beam and/or a plasma jet. When fusion is carried out without the use of an arc, there is no need for arc stabilising gases to be present in the shielding gas. Since such arc stabilising gases are typically oxidising, it has been understood in the art up to now that the use of such gases should be avoided wherever possible in order to reduce the likelihood of oxidation of the substrate and/or feedstock. However, the inventors of the present invention have surprisingly found that the use of an oxidant-containing shielding gas in an additive technique using a laser beam and/or plasma jet typically does not result in undesirable levels of oxidation to titanium and/or titanium alloys.

The fusing is preferably carried out using a plasma transferred arc. A transferred arc possesses high energy density and plasma jet velocity, thereby being particularly suitable for fusing titanium and/or titanium alloys.

The method preferably comprises laser metal deposition, plasma metal deposition and/or selective laser melting. Such techniques are particularly effective at forming an article comprising titanium and/or titanium alloys.

The feedstock may be in the form of a powder, a wire and/or a ribbon. The feedstock is preferably in the form or a powder. A powder may be positioned on the substrate more accurately, thereby enabling the article to be manufactured more precisely and with a higher level of detail.

The shielding gas preferably comprises from 40 to 3000 vpm oxidant gas, preferably from 150 to 700 vpm oxidant gas. Such oxidant gas levels are particularly effective at compensating for degassing while avoiding oxidation of the titanium and/or titanium alloy.

The oxidant gas preferably comprises one or more of oxygen, carbon dioxide, nitrogen, nitrogen monoxide, nitrous oxide and hydrogen. Oxygen may form titanium oxides and nitrogen may form titanium nitrides, both of which may provide microstructural strengthening in the metal grains.

The shielding gas preferably comprises oxygen. Oxygen gas is particularly suitable for compensating for the oxygen degassing. Preferably, the shielding gas comprises up to 200 vpm oxygen, more preferably from 5 to 175 vpm oxygen, even more preferably from 10 to 150 vpm oxygen. Such oxygen contents are particularly effective at compensating for degassing while avoiding oxidation of the titanium and/or titanium alloy.

The shielding gas preferably comprises carbon dioxide. Carbon dioxide gas is particularly suitable for compensating for the oxygen degassing. Preferably, the shielding gas comprises up to 500 vpm carbon dioxide, preferably from 100 to 400 vpm carbon dioxide, more preferably from 15 to 350 vpm carbon dioxide. Such carbon dioxide contents are particularly effective at compensating for degassing while avoiding oxidation of the titanium and/or titanium alloy.

The shielding gas preferably comprises both oxygen and carbon dioxide.

The inert gas preferably comprises a noble gas, more preferably argon and/or helium. Such gases are particularly inert and, as such, are particularly suitable for inhibiting oxidation of the liquid metal under the laser beam and/or plasma torch.

The inert gas preferably comprises from 10 to 60% by volume helium, preferably from 20 to 50% by volume helium, more preferably from 25 top 30% by volume helium. The remainder of the inert gas is typically argon.

The shielding gas may comprises unavoidable impurities, typically less that 5 vpm unavoidable impurities, more typically less than 1 vpm unavoidable impurities, even more typically less than 0.1 vpm unavoidable impurities, still even more typically less than 0.01 vpm unavoidable impurities.

In one embodiment, the shielding gas comprises from 10 to 150 vpm oxygen and the remainder argon together with any unavoidable impurities.

In a further embodiment, the shielding gas comprises from 10 to 150 vpm oxygen and the remainder helium together with any unavoidable impurities.

In a further embodiment, the shielding gas comprises from 10 to 150 vpm oxygen and the remainder helium and argon together with any unavoidable impurities.

In a further embodiment, the shielding gas comprises from 10 to 150 vpm oxygen, from 150 to 350 vpm carbon dioxide and the remainder argon together with any unavoidable impurities.

In a further embodiment, the shielding gas comprises from 10 to 150 vpm oxygen, from 150 to 350 vpm carbon dioxide and the remainder helium together with any unavoidable impurities.

In a further embodiment, the shielding gas comprises from 10 to 150 vpm oxygen, from 150 to 350 vpm carbon dioxide and the remainder helium and argon together with any unavoidable impurities.

The fusing may be carried out using a carbon dioxide laser, a solid state laser and/or a fibre laser, preferably operating at a wavelength of from 0.1 to 20 microns. Such lasers are particularly suitable for fusing titanium and/or titanium alloys.

The laser may be pulsed or continuous wave, and may be focussed to a spot of circular or non-circular shape and with an area between 0.0001 mm² and 100 mm².

The method may further comprise fusing successive layers of feedstock to the substrate. Such a method may enable larger, more complex articles to be manufactured.

In a further aspect, the present invention provides a method of laser joining and/or plasma joining titanium and/or titanium alloy, the method comprising:
providing a first workpiece;
providing a second workpiece; and
laser joining and/or plasma joining said first and second workpieces,
wherein one or both of said first and second workpieces comprises titanium or titanium alloy, and wherein said laser joining and/or plasma joining is conducted under a shielding gas comprising an inert gas and an oxidant gas.

The advantages and preferable features of the first aspect of the present invention apply equally to this aspect of the present invention.

Laser joining techniques do not make use of an arc. In plasma joining techniques, such as plasma arc welding, by positioning the electrode within the torch, the plasma arc is separated from the shielding gas. Accordingly, neither laser joining nor plasma arc joining require the presence of arc stabilising gases in the shielding gas. Since such arc stabilising gases are typically oxidising, it has been understood in the art up to now that the use of such gases should be avoided wherever possible in order to reduce the likelihood of oxidation of the workpieces. However, the inventors of the present invention have surprisingly found that the use of an oxidant-containing shielding gas in a laser joining or plasma joining technique typically does not result in undesirable levels of oxidation to titanium and/or titanium alloys.

Advantageously, the presence of the oxidant gas may also serve to improve the weld bead penetration as a result of the surface tension reduction in the melt allowing better liquid flow characteristics.

The method preferably comprises laser joining. The laser joining preferably comprises laser welding, laser hybrid welding (such as laser MIG welding), laser brazing and/or laser metal deposition. Such techniques are particularly suitable for joining titanium or titanium alloys. Such techniques typically result in high levels of oxygen degassing when carried out on titanium and/or titanium alloys. The laser welding may comprise keyhole welding. Laser welding, laser hybrid welding, laser brazing, laser soldering and laser keyhole welding are known in the art.

In a preferred embodiment, the laser joining comprises laser metal deposition. The titanium and/or titanium alloy powder deposited during such a technique is particularly reactive and exhibits particularly high gas absorption compared to, for example, titanium and/or titanium alloy wire. Accordingly, the need to compensate for degassing, and the need to avoid oxidation of the titanium and/or titanium alloy in the joint, is particularly high.

The plasma joining preferably comprises plasma brazing, plasma hybrid welding (such as plasma MIG welding) and/or plasma arc welding. Such techniques are particularly suitable for joining titanium and/or titanium alloy. The plasma arc welding preferably comprises plasma transferred arc welding. A transferred arc possesses high energy density and plasma jet velocity, thereby being particularly suitable for welding titanium and/or titanium alloy. The plasma welding may comprise keyhole welding. Plasma brazing, plasma hybrid welding, plasma arc welding, plasma transferred arc welding and plasma keyhole welding are known in the art.

In a further aspect, the present invention provides a shielding gas for use in the methods described herein comprising:
an inert gas; and
an oxidant gas comprising from 10 to 150 vpm oxygen.

The advantages and preferable features of the first aspect of the present invention apply also to this aspect of the present invention.

In a further aspect, the present invention provides the use of a shielding gas in a method of manufacturing an article comprising titanium and/or titanium alloy using an additive manufacturing method, wherein the shielding gas comprises an inert gas and an oxidant gas.

The advantages and preferable features of the first aspect of the present invention apply also to this aspect of the present invention.

In a further aspect, the present invention provides the use of a shielding gas in a method of laser joining and/or plasma joining titanium and/or titanium alloy, wherein the shielding gas comprises an inert gas and an oxidant gas.

The advantages and preferable features of the first aspect of the present invention apply also to this aspect of the present invention.

The foregoing detailed description has been provided by way of explanation and illustration, and is not intended to limit the scope of the appended claims. Many variations in the presently preferred embodiments illustrated herein will be apparent to one of ordinary skill in the art and remain within the scope of the appended claims and theft equivalents.

1-19. (canceled)

20. A method of manufacturing an article comprising titanium and/or titanium alloy using an additive manufacturing method, comprising:
providing a substrate;
providing a feedstock; and
fusing the feedstock to the substrate using a heat source,
wherein at least one of the substrate and the feed stock comprises titanium and/or titanium alloy, and the fusing is with a shielding gas comprising an inert gas and an oxidant gas.

21. The method of claim 20, wherein the fusing comprises using at least one of an arc, a laser beam, and a plasma jet.

22. The method of claim 20, wherein the fusing comprises using a plasma transferred arc.

23. The method of claim 20, further comprising at least one of laser metal deposition, plasma metal deposition, and selective laser melting.

24. The method of claim 20, wherein the feedstock is selected from the group consisting of a powder, a wire, and a ribbon.

25. The method of claim 20, wherein the shielding gas comprises from 40 to 3000 vpm oxidant gas.

26. The method of claim 20, wherein the oxidant gas comprises a gas selected from the group consisting of oxygen, carbon dioxide, nitrogen, nitrogen monoxide, nitrous oxide, and hydrogen.

27. The method claim 20, wherein the shielding gas comprises from 5 to 200 vpm oxygen.

28. The method of claim 20, wherein the shielding gas comprises from 100 to 500 vpm carbon dioxide.

29. The method of claim 20, wherein the inert gas comprises a gas selected from the group consisting of argon and helium.

30. The method of claim 20, wherein the inert gas comprises from 10 to 60% by volume helium.

31. The method of claim 20, wherein the fusing comprises using a laser selected from the group consisting of a carbon dioxide laser, a solid state laser, and a fibre laser, said laser operating at a wavelength of from 0.1 to 20 microns.

32. The method of claim 20, wherein the fusing further comprises fusing successive layers of feedstock to the substrate.

33. A method of laser joining and/or plasma joining titanium and/or titanium alloy, comprising:
providing a first workpiece;
providing a second workpiece; and
laser joining and/or plasma joining said first and second workpieces,
wherein at least one of said first and second workpieces comprises titanium or titanium alloy, and wherein said laser joining and/or said plasma joining is with a shielding gas comprising an inert gas and an oxidant gas.

34. The method of claim 33, wherein the laser joining comprises welding selected from the group consisting of laser welding, laser brazing, and laser direct deposition.

35. The method of claim 33, wherein the plasma joining comprises at least one of plasma brazing, plasma arc welding, and plasma transferred arc welding.

36. A shielding gas for use in additive manufacturing of an article having titanium therein, comprising:
an inert gas; and
an oxidant gas comprising from 10 to 150 vpm oxygen.

37. Using a shielding gas in a method of additive manufacturing an article having titanium therein, wherein the shielding gas comprises an inert gas and an oxidant gas.

38. Using a shielding gas in a method of at least one of laser joining and plasma joining titanium and/or titanium alloy, wherein the shielding gas comprises an inert gas and an oxidant gas.
